(19) United States
(12) Patent Application Publication
(10) Pub. No.: US 2019/0133376 A1
(43) Pub. Date: May 9, 2019

(54) RACK FOR SUPPORTING MEAT IN A DEEP FRYER

(71) Applicant: RESFAB EQUIPMENT INC., St-Jean-Sur-Richelieu (CA)

(72) Inventors: Robert MASSÉ, Saint-Jean-sur-Richelieu (CA); Meissa Cellé NDIAYE, Montreal (CA)

(21) Appl. No.: 16/184,008

(22) Filed: Nov. 8, 2018

Related U.S. Application Data
(60) Provisional application No. 62/583,569, filed on Nov. 9, 2017.

(51) Int. Cl. A47J 37/12; A47J 43/18

(52) U.S. Cl. CPC A47J 37/1295; A47J 37/1271; A47J 43/18

(57) ABSTRACT

There is disclosed a rack for supporting pieces of meat within oil in a deep fryer. The rack includes a structure and one or more meat supporting members supported by the structure. The meat supporting members extend along a longitudinal axis and are spaced apart from neighbouring elements of the rack by a minimal distance in a radial direction relative to the longitudinal axis. The minimal distance is selected such that, when mounted on a first one of the meat supporting members, each of the pieces of meat is free from contact with the neighbouring elements of the rack and/or free from contact with adjacent pieces of meat received on a second one of the meat supporting members.

### CROSS-REFERENCE TO RELATED APPLICATIONS

The present application claims priority on U.S. Patent Application No. 62/583,569 filed Nov. 9, 2017, the entire contents of which are incorporated by reference herein.

### TECHNICAL FIELD

The application relates generally to deep fryers and, more particularly, to systems and methods to cook meat, such as chicken, therein.

### BACKGROUND OF THE ART

Chickens are often cooked in a roaster (or rotisserie) inside which the chickens rotate on a spit, which rotates around a central axis. However, this method provides a number of inconveniences. For example, the cooking time is relatively long. Hence, a user of such chicken rotisseries must either buy many rotisseries to be able to provide a minimum number of chickens to his clients, or keep the cooked chicken under a food warmer. Prolonged time under such warmers might impair texture and taste of the chickens, which is undesirable. Moreover, such roasters are quite cumbersome, messy and/or time consuming to clean, often requiring at least two employees that must use strong chemicals to dislodge chicken pieces that have fallen off the chickens during roasting. Hence, there is a desire for alternate ways of cooking chickens and thus for the related equipment required to do so.

### SUMMARY

There is accordingly provided a rack for supporting pieces of meat within oil in a deep fryer, comprising: a base; and posts supported by the base and extending away therefrom along longitudinal axes of the posts, the posts disposed at angles relative to the base and configured to be inserted in the pieces of meat to maintain the pieces of meat at said angles while remaining submerged within the oil of the deep fryer, the posts separated from each other by a minimum distance taken along a radial direction relative to the longitudinal axes, the minimum distance selected such that two pieces of meat received on two adjacent ones of the posts are substantially free of contact with each other.

There is also provided a rack for supporting pieces of meat within oil in a deep fryer, comprising a structure and one or more meat supporting members supported by the structure, the one or more meat supporting members extending along a longitudinal axis and being spaced apart from neighbouring elements of the rack by a minimal distance in a radial direction relative to the longitudinal axis, the minimal distance selected such that, when mounted on a first one of the meat supporting members, each of the pieces of meat is free from contact with the neighbouring elements of the rack and/or free from contact with adjacent pieces of meat received on a second one of the meat supporting members.

There is further provided a rack for supporting pieces of meat within oil in a deep fryer, comprising; a base, at least one upstanding portion secured to the base and extending away from the base; and meat supporting members supported by the at least one upstanding portion, the meat supporting members extending from the at least one upstanding portion along longitudinal axes thereof, the meat supporting members separated from each other by a minimum distance taken along radial directions relative to the longitudinal axes, the minimum distance selected such that two pieces of meat received on two adjacent ones of the meat supporting members are substantially free of contact with each other.

In an alternate aspect, there is provided a rack for supporting a number of pieces of meat within oil in a deep fryer, comprising a base configured to be substantially parallel to a level of the oil in the deep fryer, posts extending away from the base and disposed at an angle relative to the base, the posts are separated from each other by a minimum distance selected such that contact between the pieces of meat is limited, the posts configured to be inserted in the pieces of meat to maintain the pieces of meat at said angle while remaining submerged within the oil of the deep fryer.

In another alternate aspect, there is provided a method of cooking pieces of meat in a deep fryer, comprising: providing a rack having a plurality of posts disposed at an angle relative to a base of the rack; sliding a piece of meat onto each of the posts, wherein each of the pieces of meat is held at said angle without touching adjacent ones of the pieces of meat; lowering the rack into oil of the deep fryer to submerge the pieces of meat within the oil; and removing the pieces of meat from the posts once the pieces of meat are cooked.

In yet another alternate aspect, there is provided a rack for supporting a number of pieces of meat within oil in a deep fryer, comprising a base and upstanding portions extending upwardly from the base, the rack further including elongated meat supporting members extending from the base or from at least one of the upstanding portions, the meat supporting members separated from each other by a minimum distance selected such that contact between the pieces of meat is limited, and the meat supporting members configured for being inserted in or through the pieces of meat.

### BRIEF DESCRIPTION OF THE DRAWINGS

Reference is now made to the accompanying figures in which:

FIG. 1 is a schematic three-dimensional view of a rack for chicken in accordance with one embodiment;

FIG. 2 is another schematic three-dimensional view of the rack of FIG. 1;

FIG. 3 is a schematic three-dimensional top view of a variation of the rack for chicken shown in FIG. 1;

FIG. 4 is a schematic three-dimensional view of another variation of the rack for chicken shown in FIG. 1;

FIG. 5 is a schematic three-dimensional view of another variation of the rack for chicken shown in FIG. 1;

FIG. 6 is a schematic three-dimensional view of another variation of the rack for chicken shown in FIG. 1;

FIG. 7 is a schematic three-dimensional view of another variation of the rack for chicken shown in FIG. 1;

FIG. 8 is a schematic three-dimensional view of another variation of the rack for chicken shown in FIG. 1;

FIG. 9 is a schematic three-dimensional view of another variation of the rack for chicken shown in FIG. 1;

FIG. 10 is a schematic three-dimensional view of another variation of the rack for chicken shown in FIG. 1;

FIGS. 11a to 11c are schematic views of a spear to be used in conjunction with any of the racks disclosed in FIGS. 1-10;

FIG. 12 is a schematic tridimensional view of a fork used to release the chickens from posts of any of the racks of FIGS. 1-10;

FIGS. 13a and 13b are schematic three-dimensional views of a rack in accordance with another embodiment;

FIG. 13c is a schematic three-dimensional view of a meat supporting member of the rack of FIG. 13a;

FIG. 14 is a schematic three-dimensional view of a variation of the rack shown in FIG. 13a;

FIG. 15 is a schematic three-dimensional view of another variation of the rack shown in FIG. 13a;

FIG. 16 is a schematic three-dimensional view of another variation of the rack shown in FIG. 13a; and

FIG. 17 is a schematic three-dimensional view of another variation of the rack shown in FIG. 13a.

### DETAILED DESCRIPTION

Chickens and/or other types of meat can be cooked using a method called free frying. Free frying typically consists of simultaneously frying a plurality of chickens (other pieces/types of poultry, meat, etc.) by submerging them, unsupported, in oil and by allowing them to circulate freely within a deep fryer. However, chickens cooked in this manner tend to stick to one another if they touch each other. Because the skin of chicken becomes quite delicate during such a deep frying process, it can become damaged when the chickens touch each other. Manually separating the chickens might also tear their skin, resulting in damaged chickens that have an unappealing appearance and/or a lower quality taste. This is not desirable.

While deep frying remains a desirable way to cook chickens and provides certain advantages over chickens cooked by roasting on a rotating rotisserie spit, as noted above, improvements on the free frying process described above is sought.

There is therefore disclosed herein a rack for supporting a number of pieces of meat during the frying process. It is understood that although the below description and figures illustrate and refer to birds, such as but not limited to chickens, the rack may be configured to cook any pieces of meat such as, any kind of poultry/bird (e.g., turkey, goose, duck, quail) and any kind of other livestock (e.g., chops, roast beef, roast pork, and sausages). The term “meat” as used herein is understood to include any and/or all of such animal products.

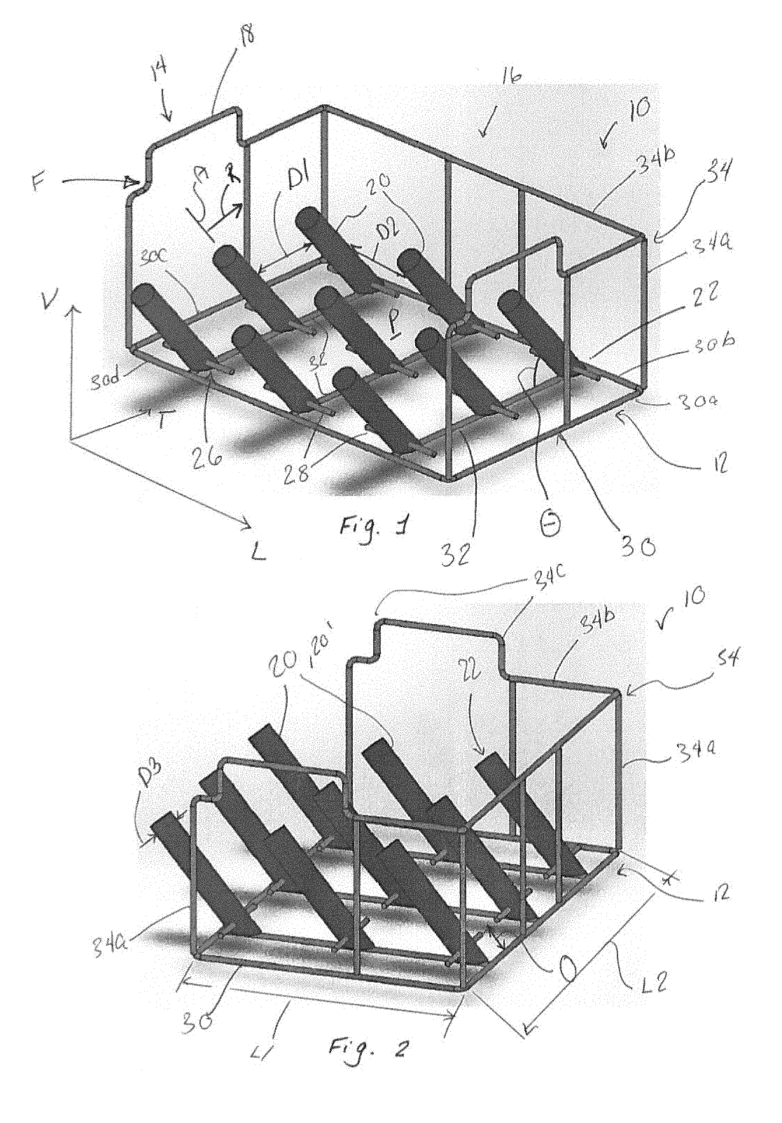

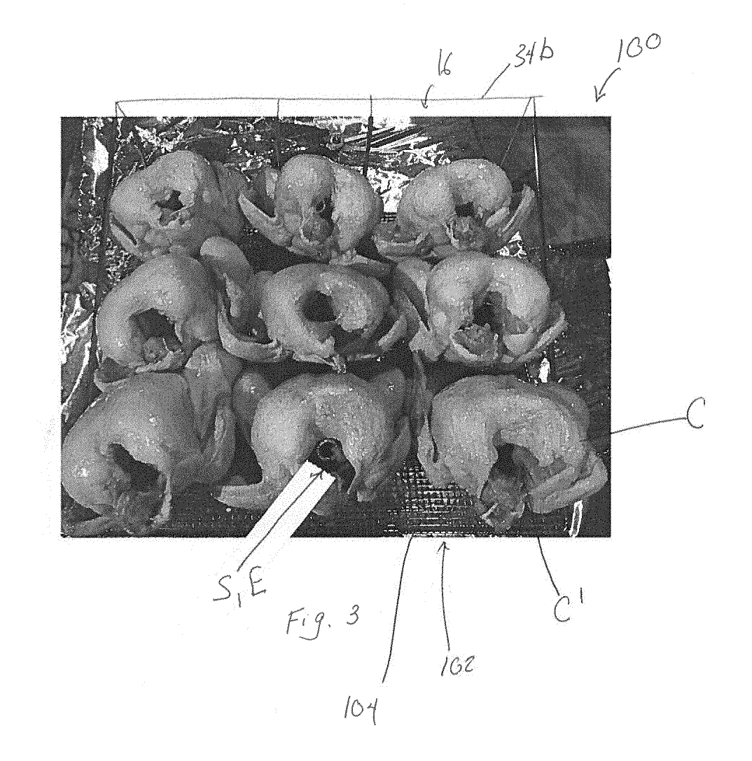

The present rack for cooking chickens in a deep fryer is illustrated in FIGS. 1-2 and referred to by numeral 10. The rack defines longitudinal L, transversal T, and vertical V axes. The rack 10 has a base 12 extending along the longitudinal and transversal axes L, T and configured to be substantially parallel to a level of oil in the deep fryer (not shown). The rack 10 further has side portions 14 and a back portion 16 all affixed to the base 12 and extending vertically therefrom along the vertical axis V. The side and back portions 14, 16 are used to add structural integrity to the rack 10. In the embodiment shown, the side portions 14 include handles 18 for moving the rack 10 in and out of the oil of the deep fryer. The base 12, the side portions 14, the back portions 16, and the handles 18 are, in at least one embodiment, part of a structure S of the rack 10.

Still referring to FIGS. 1 and 2, the rack 10 is configured for holding the chickens C (FIG. 3) individually. In the embodiment shown, the rack 10 further includes posts 20, also referred to as meat supporting members, configured to carrying this function. The posts 20 are supported by the structure S. In the embodiment shown, the posts 20 are supported by the base 12. The posts 20 may be removably securable to the base 12. In a particular embodiment, the base 12 may include a plurality of post receiving portions configured for being engaged by the posts 20; a configuration of the rack 10 may be changed by adding/removing posts 20 such that the rack may be tailored to cater to different sizes of birds, or other pieces of meat. The posts 20 extend away from the base 12 along respective longitudinal axes A that define an angle θ with a plane P defined by the longitudinal and transversal axes L, T. Each of the posts 20 is configured to be inserted in a cavity C′ (FIG. 3) of a chicken C for supporting the chicken C during the cooking process in the deep fryer. It is understood that the posts 20 need not be parallel to each other and that each of the posts 20 may be secured to the base 12 and intersect the base 12 at its own respective angle relative to the base 12. In other words, two posts 20 may extend away from one another from first ends secured to the base 12 to remote ends. All the posts of a given row or column of posts 20 may be parallel to each other.

The angle θ may be less than or equal to 90 degrees. An angle less than 90 degrees might allow reducing an effective height of a chicken C supported by the posts 20. The effective height of a chicken C is calculated by the real height of the chicken—measured along its cavity C′—multiplied by the sinus of the angle. By having an effective height less than the real height might allow the chicken C to be fully submerged in, or covered by, oil without having to add supplemental oil in the deep fryer. The angle θ may be selected depending of the size of the chickens to cook. The angle may be inversely proportional to the size, or real height, of the chicken. In the embodiment shown, the angle θ is about 45 degrees, however in alternate embodiments the angle θ may be from 20 to 90 degrees, more specifically from 25 to 90 degrees. In a particular embodiment, the angle may be between 0 and 90 degrees.

In the depicted embodiment, as all of the posts 20 are identical, only one of which is described herein below. Hence, the below description may apply to all of the posts 20. The post 20 extends from a base end 22 to a free 24 end along its central, or longitudinal, axis A. The base end 22 is affixed to the base 12. The base end 22 may be removably securable to the base 12.

Each of the posts 20 is spaced apart from neighbouring elements of the rack 10 by a minimal distance in a radial direction R relative to the longitudinal axis A. The minimal distance is selected such that, when mounted on a first one of the posts 20, each of the chickens C is free from contact with the neighbouring elements of the rack 10 and/or free from contact with adjacent chickens C received on a second one of the posts 20. The neighbouring elements are any parts belonging to the structure F of the rack 10 and/or the neighbouring posts 20.

In the embodiment shown, the post 20 is distanced from immediate neighbouring posts 20 by a given transversal and longitudinal distances D1 and D2. The distances D1, D2 are selected so that the chickens do not touch each other at least during the frying process, or that contacts between the chickens are minimized or limited. Precluding the chicken from touching each other might preclude them to stick to one another during cooking. The distances D1, D2 may be equal and selected based on the size of the chicken to cook and may generally corresponds to a diameter of one of the chickens. Alternately, the distance D1 may be different than the distance D2 to cater to a shape of the chickens. In the embodiment shown, the rack is configured for cooking chickens having a given weight. The distances D1, D2 are selected in accordance with the given weight of the chickens to cook.

The post 20 may be hollow or closed. An external diameter D3 of the post 20 may be selected to be smaller than the cavity C′ of the chicken C such that, first, the chickens C slide easily on the post 20, and, second, an annular space S extending around the post 20 is defined. In the embodiment shown, the external diameter D3 of the post 20 may be selected depending of the size of the meat (e.g., bird/poultry, livestock) to cook. In the embodiment shown, the post 20 is cylindrical. Alternately, the post 20 may be conical having a diameter decreasing in a direction away from the base 12. Such a conical shape might prevent the chickens C from touching the base 12 and might contribute in holding the chickens C during the cooking process.

The annular space S is bounded by the post and by a peripheral surface E of the cavity C′ of the chicken C. The annular space S might allow oil of the deep fryer to contact the peripheral surface E of the cavity C ‘of the chicken C. Hence, the chicken might be cooked simultaneously from the inside and from the outside. This might reduce the cooking time. The post might be hollow such that oil may circulate therethrough to fill the cavity C’ of the chicken C with oil. Furthermore, the post 20 might get heated by the oil circulating therein. The post 20 might transfer its heat to the chicken C to help the cooking process. Alternately, the post 20 may be made of any suitable longitudinally extending member suitable for supporting the chicken.

In the embodiment shown, each of the posts 20 is provided with a stopper 26 for preventing the chickens C to slide down and come into contact with the base 12 and/or for preventing the chickens C to move relative to the rack 10 during the cooking process. The stopper 26 is disposed proximate the base end 22 and is spaced apart from the base 12 by an offset distance O along the post longitudinal axis A. In the embodiment shown, the offset distance O is selected depending on the meat that has to be cooked.

In the illustrated embodiment, the stopper 26 is defined by two longitudinal tabs 28 extending radially from the post 20 relative to its longitudinal axis A and in diametrically opposed directions. The two tabs 28 may be made of a single rod extending through the post 20 and supported at its center by said post 20. Other configurations are also contemplated. For example, the stopper 26 may be formed having a cross-shaped, or X-shaped, configuration, or may have alternate shapes and configurations. The stopper 26 may also be either integrally formed with the post 20 or may be separately formed and then fastened or fixed thereto. The stopper 26 is configured to abut a rear section of a chicken such that an extremity of the chicken thigh bones is not compressed against the base 12.

In the embodiment shown, the base 12 has a frame 30 having four sides 30a, 30b, 30c, 30d disposed to define a rectangular or square shape. The four sides include two transversal sides 30a, 30c and two longitudinal sides 30b, 30d. The longitudinal sides 30b, 30d extend along axis L and are distanced from one another along the transversal axis T. The transversal sides 30a, 30c extend along the transversal axis T and are distanced from one another along the axis L. In the embodiment shown, the frame 30 is made of a single rod that is bent to form the rectangular, or square, shape. The frame 30 may also be made of a plurality of rods welded at their extremities to define the rectangular shape. Other configurations are contemplated. The frame 30 is part of the structure F of the rack 10.

As illustrated, the base 12 further includes three support rods 32, which are elements of the structure F, equidistantly spaced from each other and extending perpendicularly from one of the two longitudinal sides 30b to the other of the two longitudinal sides 30d. In the embodiment shown, the support rods 32 are welded on the longitudinal sides 30b, 30d of the frame 30. Each of the three support rods 32 has three of the posts 20 affixed thereon, for a total of nine posts. The posts 20 may be welded on the support rods 32. It is understood that the rack 10 may be made bigger or smaller to cater to more or less than nine chickens and to maximize an available space within the fryer. The rack 10 is suitably dimensioned or tailored to fit a given fryer. The rack 10 may comprise more than three support rods 32 and/or each of the transversal sides 30a, 30c may be longer to accommodate more than three posts 20. Other configurations are contemplated. In the embodiment shown, the support rods 32 extend parallel to the transversal sides 30a, 30c of the frame 30 that have a length L1 less than a length L2 of the longitudinal sides. Hence, a weight-induced deflection of the support rods 32 might be less than if the support rods were extending parallel to the longitudinal sides 30b, 30d. In the embodiment shown, the lengths L1, L2 are selected depending on the size of the fryer.

In a particular embodiment, the base 12 includes three supplementary rods, which are elements of the structure F, disposed perpendicularly to the three support rods 32 for improving a structural integrity of the base 12. The rods 32 and the supplementary rods are crossed in both directions. In this particular embodiment, the posts are attached to intersections of the three support rods 32 and the supplementary rods.

Still referring to FIGS. 1-2, the side portions 14 and the back portion 16 are defined by a vertical frame 34 extending on three out of the four sides of the base. The back portion 16 extends along one of the two longitudinal sides 30b of the frame 30 and the side portions 14 extend along both of the two transversal sides 30a, 30c of the frame 30. The vertical frame 34 is composed of eight vertical rods 34a extending from the frame 30 along the vertical axis V, and of a top rod 34b that is bent to extend along the three sides of the base 12. Each of the eight vertical rods 34a is connected, by welding, perpendicularly to the top rod 34b. It is understood that the top rod 34b may be replaced by three rods welded at their extremities. Other configurations are contemplated. The frame 34 is an element of the structure F

As illustrated, the top rod 34b defines the two handles 18 at the side portions 14 of the vertical frame 34. More specifically, the top rod 34b defines a plurality of 90-degree elbows 34c to define the handles 18 that are elevated along the vertical axis relative to a remainder of the top rod 34b. The handles 18 are configured to remain above a level of oil of the deep fryer when the chickens C are submerged in the oil. Hence, the rack 10 may be inserted and withdrawn from the oil using the two handles 18 without having to touch the oil.

Referring now also to FIG. 3, another embodiment of a rack 100 for chickens C is illustrated. In the embodiment shown, the rack 100 includes a base 102 that includes a mesh 104 that extends over an area defined by a frame of the base 102. The posts 20 are affixed to the mesh 104. The posts 20 may be welded on the mesh 104.

In the embodiment shown, the handles 18 are omitted and the rack 100 is configured to be is used in conjunction with an automatic deep fryer that includes a lifting mechanism to automatically move the rack 100 in and out of the oil. In such a case, the top rod 34b at the back portion 16 of the vertical frame 34 is engageable by the mechanism to move the rack and the chickens supported thereon. The rack 12 may be designed specifically to be operated by a specific type of lifting mechanism.

Referring to all figures, to operate the rack 10, 100, the posts 20 of the rack are slid in cavities C′ of the chickens C. The rack 10, 100 is lowered to submerge the chickens C within the oil contained in the deep fryer. The chickens C are then removed from the posts 20. In the embodiment shown, the rack 10, 100 is lifted out of the oil of the deep fryer before removing the chickens C from the posts 20. In the depicted embodiment, the chickens C are slid on the posts 20 before lowering the rack 10, 100 in the oil. The chickens C may be oriented such that their thighs are oriented toward the base 12 of the rack. The chickens C may be alternately oriented such that the thighs are upwards, away from the base 12.

As illustrated, sliding the posts 20 in the cavities C′ of the chickens C includes inserting the posts 20 in the cavities C′ until stoppers 26 of the posts 20 abut against the chickens C. Lowering the rack 10 may be carried by lowering the rack with the two handles 18 vertically spaced apart from the base 12 of the rack 10. In a particular embodiment, a user disposes of a plurality of racks that differ from each other in at least one of the angle θ between the posts 20 and the base 12 and the distances D1, D2 between two neighbouring posts 20. Each of the plurality of racks is tailored for a given size of chicken. Therefore, the rack is selected based on the size of the chickens C to cook.

In a particular embodiment, surfaces of the rack are covered with an antiadhesive coating. The coating may be, for instance, Teflon™, enamel, or any other suitable coating. In a particular embodiment, the coating is RELEASECOAT™ R-32 Industrial Nonstick Coatings PTFE/PPS made by RELEASE COATINGS™. In a particular embodiment, the coating has a maximum in use temperature of about 260 degrees Celsius. The coating is safe for food contact.

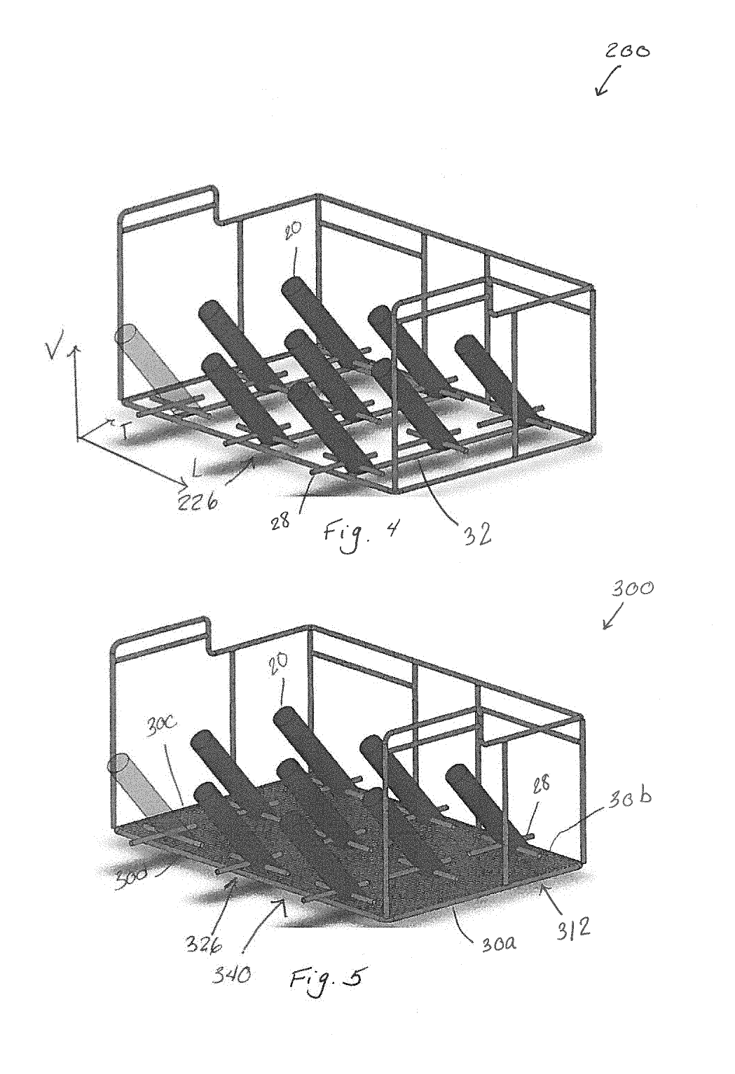

FIGS. 4-10 represent variations of the rack 10 of FIGS. 1-2. For the sake of simplicity, only elements that differ from the rack 10 of FIGS. 1-2 are described below.

Referring now to FIG. 4, another embodiment of a rack 200 is shown. The stoppers 226 include four tabs 28. Two of the four tabs are parallel to the axis L whereas the other two of the four tabs 28 are parallel to the transversal axis T. Having four tabs 28 instead of two might offer a better support for the chicken when disposed around the posts 20.

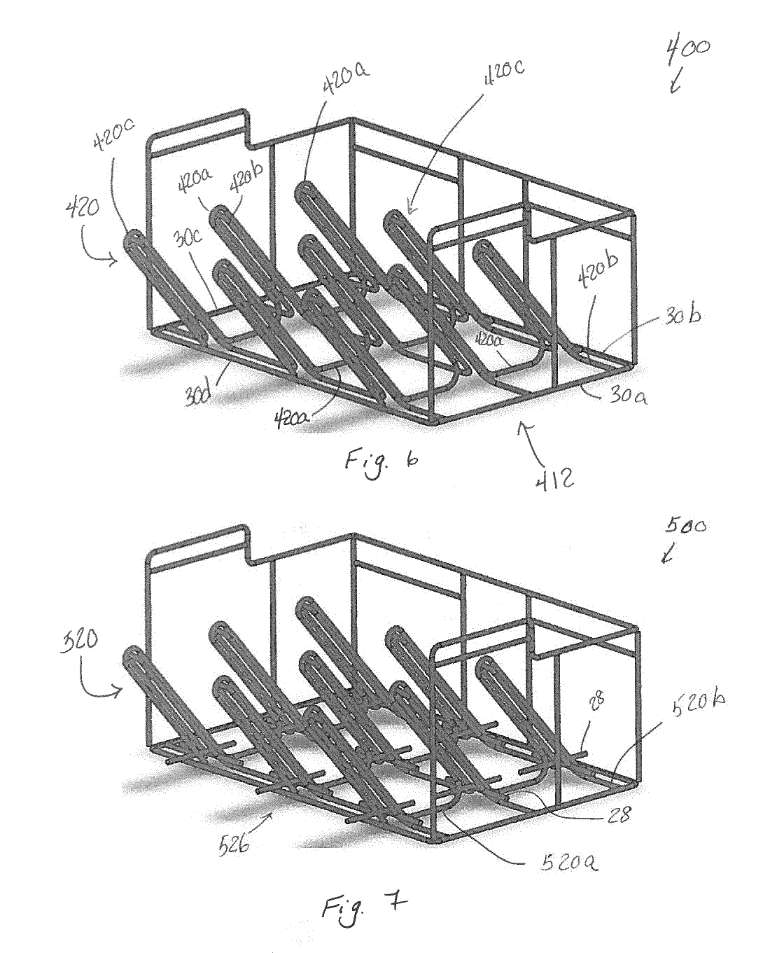

Referring now to FIG. 5, another embodiment of a rack 300 is shown. In this embodiment, the base 312 includes the four sides 30a, 30b, 30c, 30d and a wire mesh 340 welded to the four sides 30a, 30b, 30c, 30d and disposed over the supporting rods 32 (FIG. 4). In the embodiment shown, the posts 20 are welded on the wire mesh 340 and/or on the supporting rods 32. This embodiment includes spacers 326 having the four tabs 28 similar to the spacers 226 described in FIG. 4.

Referring now to FIG. 6, another embodiment of a rack 400 is shown. In this embodiment, the base 412 includes the four sides 30a, 30b, 30c, 30d, three transversal rods 420a affixed at their extremities to the longitudinal sides 30b, 30d, and three longitudinal rods 420b affixed at their extremities to the transversal sides 30a, 30c. The transversal and longitudinal rods 420a and 420b are bended such that each defines three “U”-shaped portions 420c for defining the posts 420. Each post 420 is then defined by two registering “U”-shaped portions 420c, one of which belonging to one of the three transversal rods 420a and the other of which belonging to one of the three longitudinal rods 420b.

Referring now to FIG. 7, another embodiment of a rack 500 is shown. In the depicted embodiment, the posts 520 are similar than the posts 420 of FIG. 6 and are similarly defined by transversal and longitudinal rods 520a, 520b that are similar to transversal and longitudinal rods 420a, 420b of FIG. 6. In the embodiment shown, the rack 500 includes stoppers 526 each including four tabs 28. The stoppers 526 and tabs 28 are similar than the one described with reference to FIG. 4.

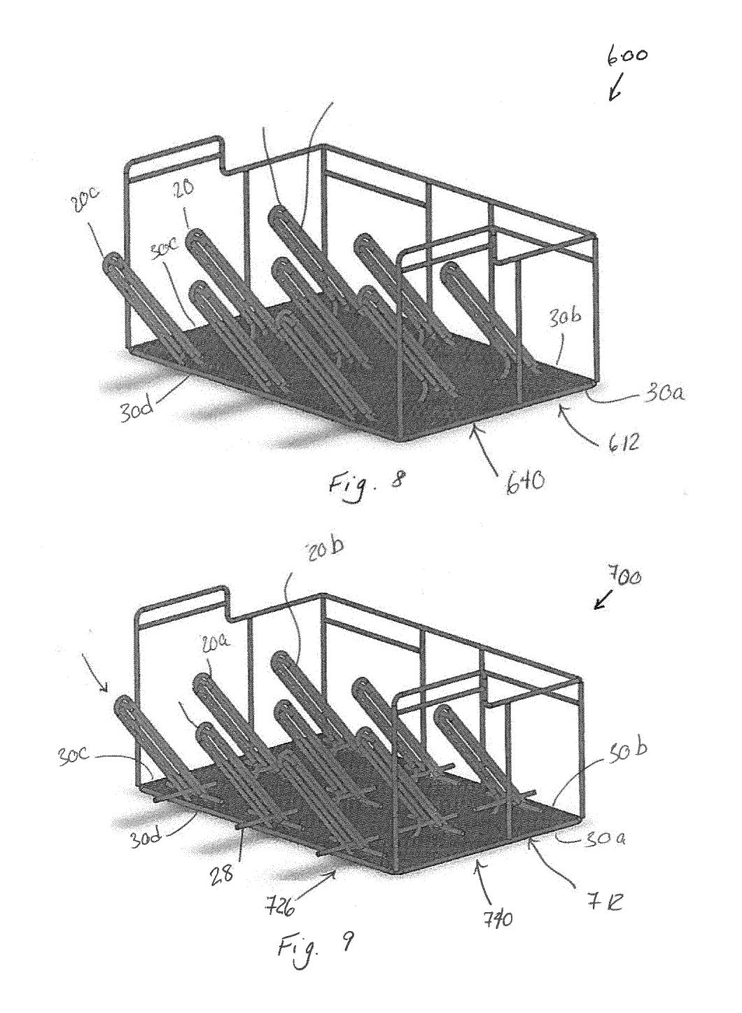

Referring now to FIG. 8, another embodiment of a rack 600 is shown. The rack 600 corresponds to the rack 400 of FIG. 6 and further includes a wire mesh 640 affixed to the base 612. More specifically, the base 612 includes the four sides 30a, 30b, 30c, 30d and the wire mesh 640 is attached (e.g., welded) to the four sides 30a, 30b, 30c, 30d. Such mesh 640 might preclude some of the pieces of the chickens C (FIG. 3) to fall off the rack and remain in a bottom of the fryer. The mesh 640 might increase time between two consecutives oil drainage compared to a configuration of the rack without a mesh.

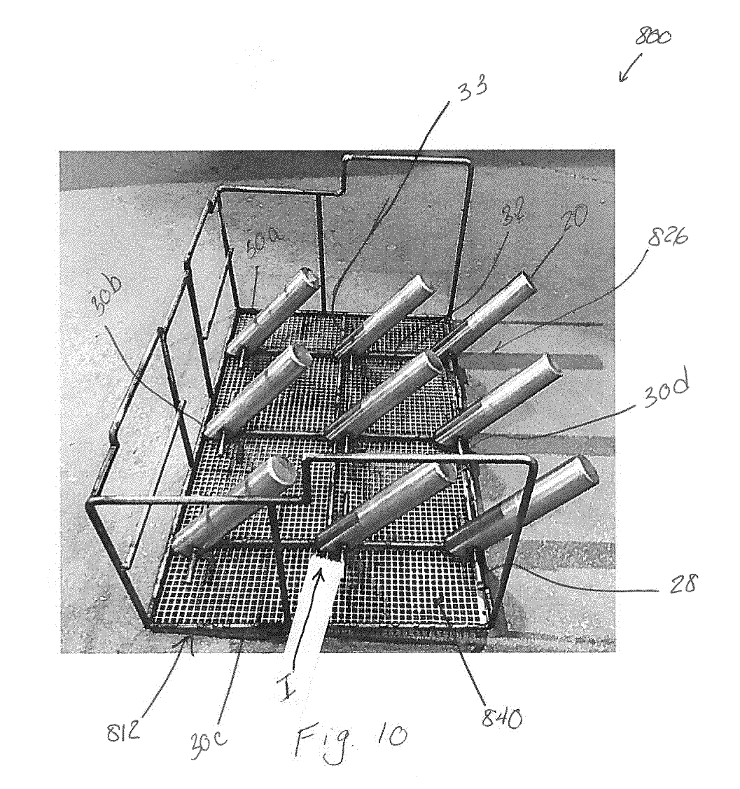

Referring now to FIG. 9, another embodiment of a rack 700 is shown. The rack 700 corresponds to the rack 500 of FIG. 7 and further includes a wire mesh 740 affixed to the base 712. More specifically, the base 712 includes the four sides 30a, 30b, 30c, 30d and the wire mesh 740 is attached (e.g., welded) to the four sides 30a, 30b, 30c, 30d. The stoppers 726 and tabs 28 are similar than the one described with reference to FIG. 4.

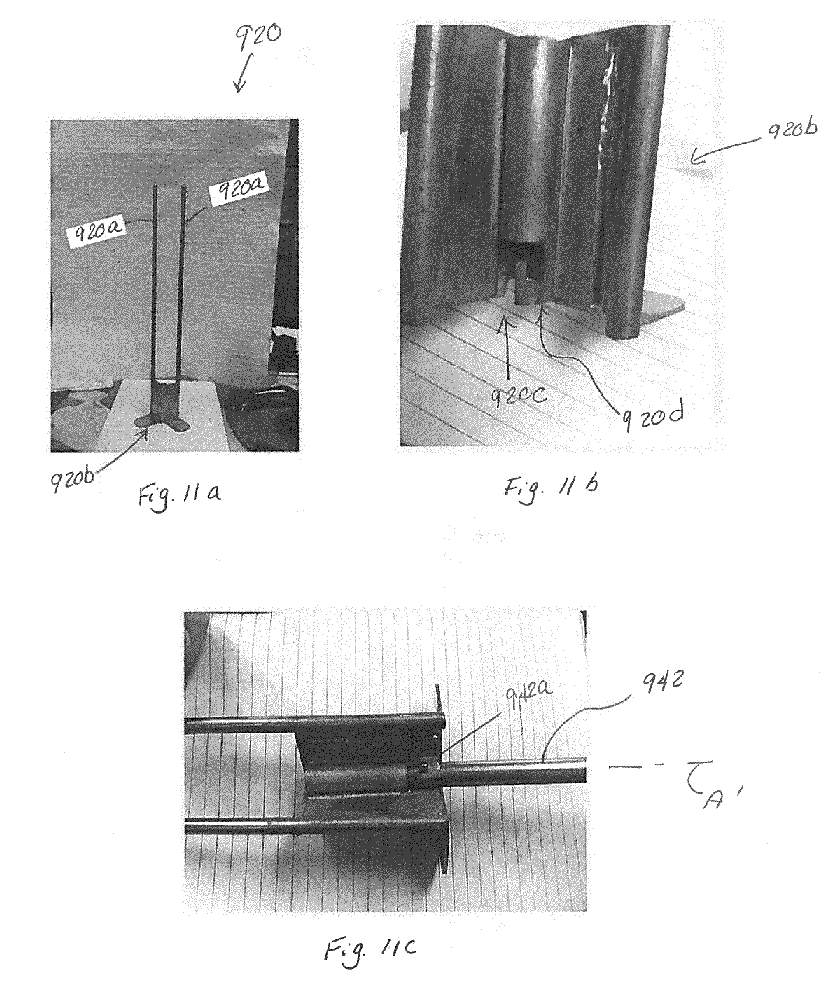

Referring to FIG. 10, another embodiment of a rack 800 is shown. The rack 800 includes posts 20 similar to the posts of FIG. 1. A base 812 of the rack 800 includes the four sides 30a, 30b, 30c, 30d, the three supporting rods 32 that extend parallel to the transversal axis T (FIG. 1), and a fourth supporting rod 33 extending parallel to the axis L (FIG. 1). The fourth supporting rod 33 perpendicularly intersects each of the three supporting rods 32. The fourth supporting rod 33 is centered between the two longitudinal sides 30b, 30d. Three of the posts 30 are disposed over intersections I between the supporting rods 32 and the fourth supporting rod 33. The base 812 further includes a wire mesh 840 disposed below the supporting rods 32, 33 and affixed (e.g., welded) to the four sides 30a, 30b, 30c, 30d. Stoppers 826 are mounted to each of the posts 20 and include each two tabs 28.

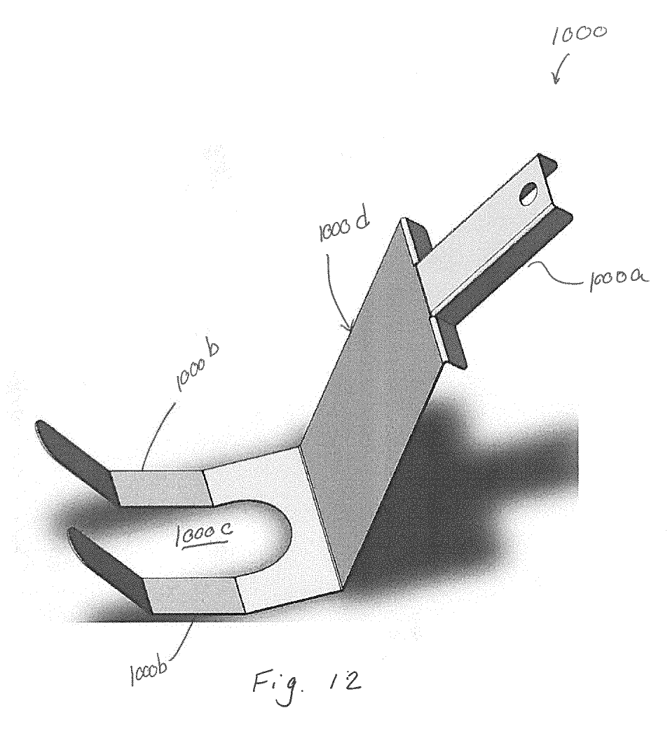

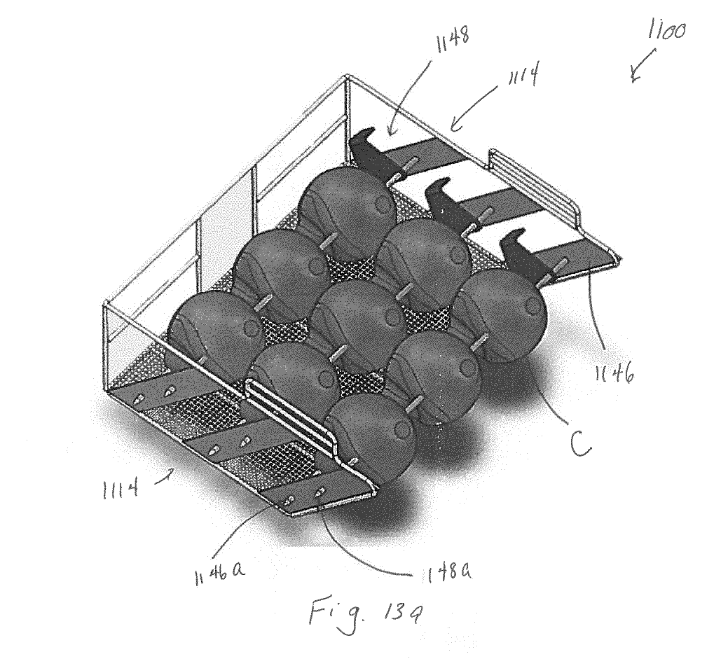

Referring now to FIGS. 11a to 11c, a post 920 in accordance with another embodiment is illustrated. The post 920, or meat supporting members take a shape of two spears 920a extending from a base 920b. The post 920 defines a slot 920c and an aperture 920d at the base 920b. As illustrated on FIG. 11c, the aperture 920d is configured for receiving therein a rod 942. The rod 942 includes a pin 942a extending perpendicularly from a longitudinal axis A′ of the rod 942. The pin 942a is configured to be slidably inserted in the slot 920c. A locking engagement is provided by the interaction of the pin 942a and the slot 920c to preclude movements of the post 920 relative to the rod 942 along its longitudinal axis A′. In such an embodiment, the post 920 is configured to receive a broad selection of pieces of meat, such as, for instance, pork chops, roast beef, and roast pork.

In a particular embodiment, a rack may include a plurality of rods 942 affixed thereon. Such a rack may be configured to interchangeably accommodate a variety of posts depending on the kind of meat to cook.

Referring now to FIG. 12, a fork 1000 in accordance with one embodiment is shown. The fork 1000 may be configured to withdraw the chickens C (FIG. 3) from the posts 20 (FIG. 1). As shown, the fork 1000 includes a handle member 1000a to be held by a user and two curved fingers 1000b spaced apart from each other to define a gap 1000c. The gap 1000c is configured to receive therein one of the posts 20. Therefore, to withdraw one of the chickens C, the fork 1000 is disposed such that one of the posts 20 is received within the gap 1000c and such that both fingers 1000b are disposed proximate the base 12 below the chicken C. The user, using the handle member 1000a, pushes on the chicken C (FIG. 3) in a direction parallel the axis A (FIG. 1) of the post 20 and toward himself. The fork 1000 might allow withdrawal of the chickens C from the posts 20 without damaging the skin of the chickens C. Once withdrawn, the chickens C may lay on a plate member 1000d of the fork 1000. Therefore, the fork 1000 may be used to withdraw the chickens C from the posts 20 and to carry the chickens C in a receptacle, or on a serving plate.

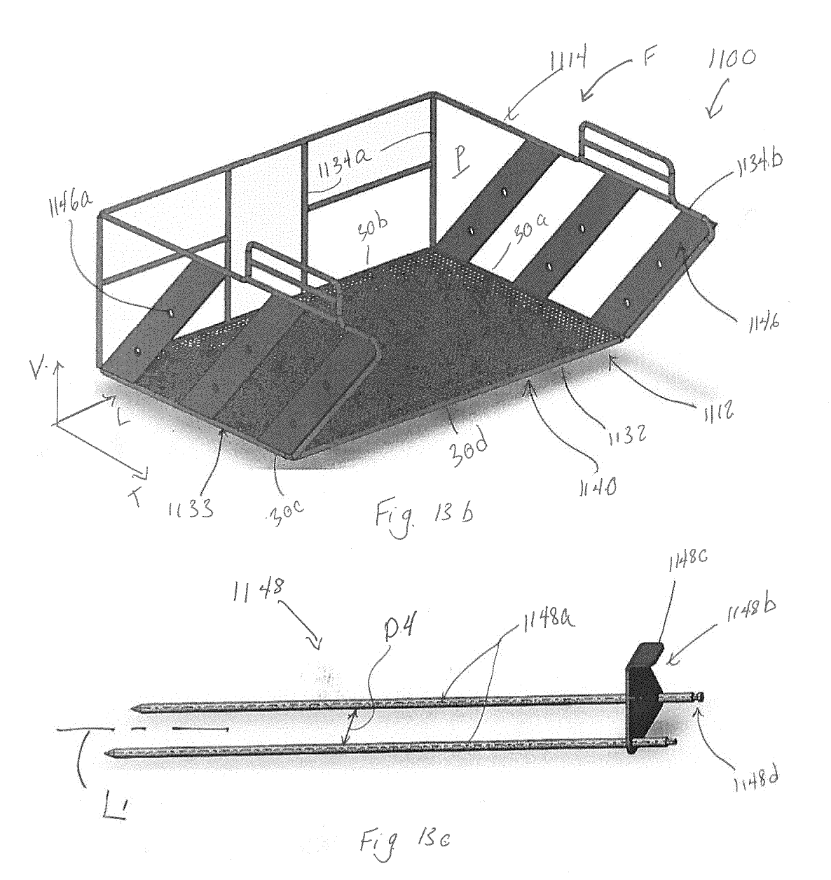

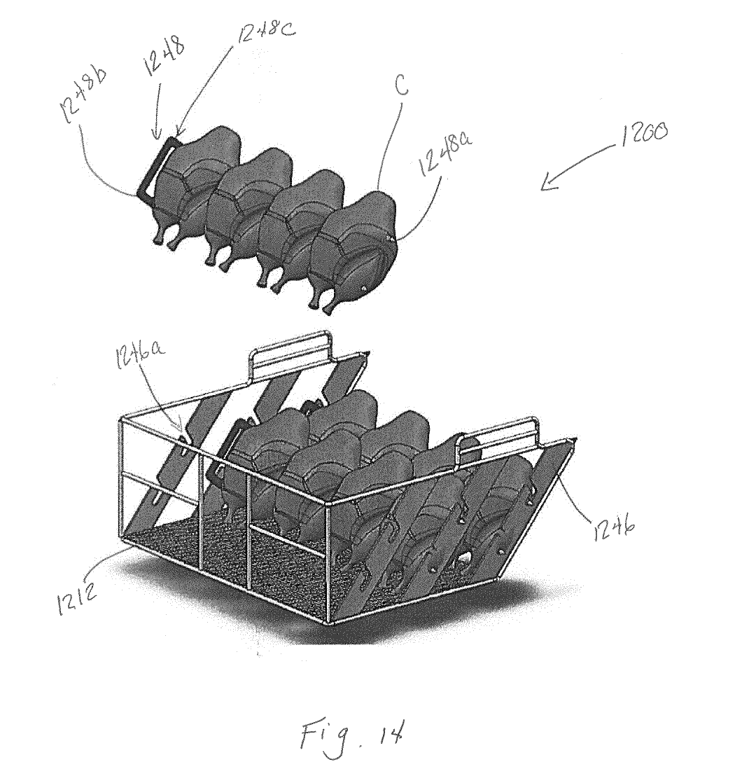

Referring now to FIGS. 13a to 13c, another embodiment of a rack 1100 is shown. The rack 1100 is configured for cocking meat, chickens C in the embodiment shown, by spearing the chickens Con spears. As illustrated, the rack 1100 has two upstanding, or side portions 1114 each including three spear supporting members 1146 defining each two apertures 1146a. The apertures 1146a are configured for slidably receiving therein meat supporting members provided in the form of spears 1148a of spears assemblies 1148. The meat supporting members have opposed ends each removably securable to a respective one of the side portions 1114. As illustrated, the spear supporting members 1146 are disposed at angles relative to the base 1112. Other configurations are contemplated. For instance, the rack 1100 may include at least one upstanding portion 1114 secured to the base 1112; the meat supporting members extending from the at least one upstanding portion 1114 along longitudinal axes L′. The meat supporting members are separated from each other by a minimum distance taken along radial directions relative to the longitudinal axes L′. The minimum distance is selected such that two pieces of meat received on two adjacent ones of the meat supporting members are substantially free of contact with each other.

As illustrated, the spear supporting members 1146 extend in a plane P parallel to a plane defined by the transversal and vertical axes T, V. The spear supporting members 1146 extend from the transversal sides 30a, 30c of the base 1112 to a top rod 1134b distanced from the base 1112 by vertical rods 1134a. The spear supporting members 1146 may be made of metal and welded on the rods 1134b,

Referring more particularly to FIG. 13c, the spear assemblies 1148 include each two spears 1148a extending parallel to one another and extending perpendicularly from a base 1148b. The spears 1148a extend on both sides of the base 1148b. The spears 1148a are configured to penetrate the chickens C in a direction perpendicular to their cavities C′ (FIG. 3). A tab 1148c at the base 1148b may be used for manipulating the spit and/or for alignment and attachment purposes on the rack. An extremity of one of the spears 1148a proximate the base 1148b defines a notch 1148d that may be sized for engaging a peripheral wall of the apertures 1146a for limiting movements of the spear assemblies 1148 relative to spear supporting members 1146 during the cooking process. A distance D4 between the two spears 1148a is selected depending on a size of the chickens C (or any other piece of meat) to cook.

To operate the rack 1100, the chickens C are speared on the spears 1148a. Then, each of the spears 1148a is positioned between two respective ones of the spear supporting members 1146. More specifically, the spears 1148a are inserted in respective apertures 1146a of the two respective ones of the spear supporting members 1146.

In the embodiment shown, the base 1112 of the rack 1110 includes a wired mesh 1140 supported by three underlying supporting rods 1132 and by a fourth supporting rods 1133 extending perpendicularly to the three supporting rods 1132. Other configurations are contemplated.

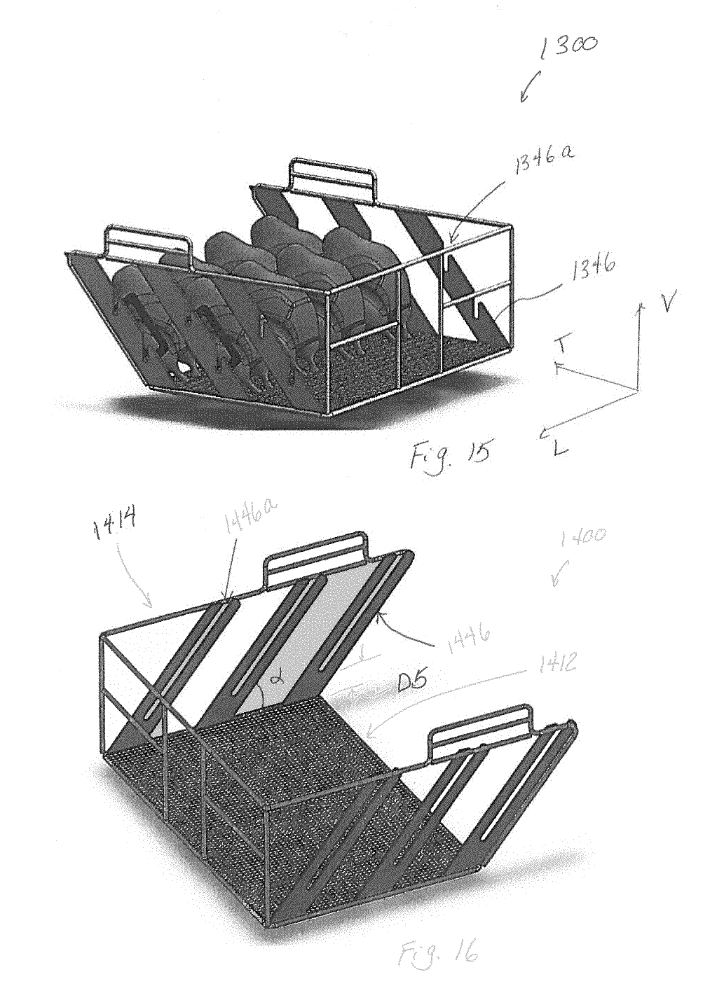

Referring now to FIG. 14, a rack 1200 in accordance with another embodiment is shown. The rack 1220 is similar than the rack 1100 illustrated in FIG. 13a. In this embodiment, the rack 1200 includes spear supporting members 1246 that extends away from a base 1212. Each of the spear supporting members 1246 includes two slots 1246a for receiving therein spears 1248a of spear assemblies 1248, which are similar than the spears 1148a of FIG. 13c. In the embodiment shown, the slots have an “L”-shape and are designed/oriented such that a buoyancy force of the chickens C in oil does not disengage the spears 1148a from within the slots 1146a. Other configurations are contemplated.

In the depicted embodiment, the spear assemblies 1248 include each a base 1248b that supports the spears 1248a. The base 1248b defines an aperture 1248c such that the base 1248b may be used as a handle for allowing a user to insert and withdraw the spear assemblies 1248, and the chickens C mounted thereon, in and out of the rack 1200.

Referring now to FIG. 15, a rack 1300 in accordance with another embodiment is shown. The rack 1300 is similar to the rack 1200 illustrated in FIG. 14 excepts that slots 1346a of spear supporting members 1346 are vertically aligned with respect to vertical axis V.

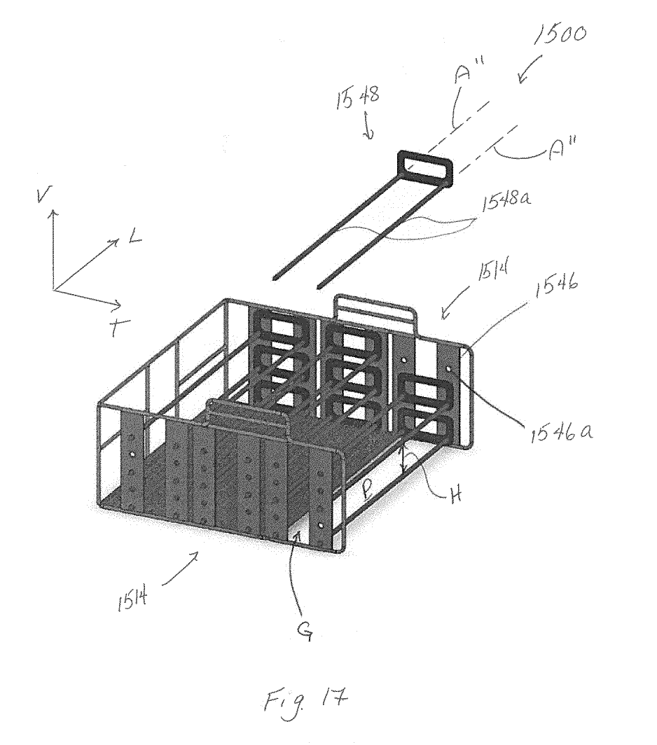

Referring now to FIG. 16, a rack 1400 in accordance with another embodiment is shown. The rack 1400 is similar to the rack 1200 illustrated in FIG. 14 excepts that the spear supporting members 1446 defines slots 1446a that extend at an angle α relative to the base 1412. In the embodiment shown, the slots 1446a extends from a location distanced from the base 1412 by a distance D5 to a top of side portions 1414 of the rack 1400. The distance D5 and the angle α are selected depending on the type of meat to cook.

Referring now to FIG. 17, a rack 1500 in accordance with another embodiment is shown. The rack 1500 is similar than the rack 1100 of FIG. 13a and is configured to be used with spear assemblies 1548 similar than the spear assemblies 1248 of FIG. 14. In the embodiment shown, the rack 1500 includes twelve spear supporting members 1546, six on each of side portions 1514. Each of the spear supporting members 1546 defines apertures 1546a separated from one another along the vertical axis V. The rack 1500 is configured for supporting nine spear assemblies 1548 disposed in three rows along the transversal axis T and three stacks along the vertical axis V.

As illustrated, the spear assemblies 1548 are received within the rack 1500 such that, for each of the spear assemblies 1548, a plane containing longitudinal axes A″ of the two spears 1548a is parallel to a plane P defined by the longitudinal and transversal axes L, T. As shown, the spears 1548a of the spear assemblies 1548 are slidably received at both of their extremities within the apertures 1546a of the spear supporting members 1546. In the embodiment shown, the rack 1500 is used to cook a plurality of 5-pound turkey breast.

In a particular embodiment, more apertures 1546a may be defined to vary a height H between two vertically adjacent spear assemblies 1548 to cater to variations in sizes of the turkey and/or to allow simultaneously cooking more than one kind of meat. Alternately, the plurality of apertures 1546a may be used to tilt the spear assemblies 1548 to vary an angle between the spear longitudinal axes A″ and the plane P.

In a particular embodiment, the spear supporting members 1546 may be replaced by two plates, one on each of the side portions 1514, defining the required apertures 1546a for receiving the spear assemblies 1548. However, it might be preferable to have gaps G between spear supporting members 1546 to allow a flow of oil in and out of the rack 1500 via the gaps G for improving cooking uniformity.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A rack for supporting pieces of meat within oil in a deep fryer, comprising: a base; and posts supported by the base and extending away therefrom along longitudinal axes of the posts, the posts disposed at angles relative to the base and configured to be inserted in the pieces of meat to maintain the pieces of meat at said angles while remaining submerged within the oil of the deep fryer, the posts separated from each other by a minimum distance taken along a radial direction relative to the longitudinal axes, the minimum distance selected such that two pieces of meat received on two adjacent ones of the posts are substantially free of contact with each other.

2. The rack of claim 1, further comprising stoppers affixed to the posts at distances from the base along the longitudinal axes of the posts, the stoppers configured for limiting contact between the pieces of meat and the base.

3. The rack of claim 2, wherein the stoppers are tabs extending transversely relative to the longitudinal axes of the posts.

4. The rack of claim 1, wherein the pieces of meat are birds, the posts configured to be inserted in cavities of the birds.

5. The rack of claim 1, wherein the base includes supporting rods extending parallel to a plane defined by the base, the posts affixed to the supporting rods.

6. The rack of claim 1, wherein the angles are selected so that the pieces of meat are entirely covered by oil when in the deep fryer.

7. The rack of claim 1, wherein the angles are about 45 degrees.

8. The rack of claim 1, wherein the angles range between 0 to 90 degrees.

9. The rack of claim 1, wherein the angles range from 20 to 90 degrees.

10. The rack of claim 1, further comprising a back portion operatively connected to the base on a longitudinal side thereof and extending upwardly therefrom, the back portion configured to be engaged by a lifting mechanism of the deep fryer.

11. The rack of claim 1, further including an antiadhesive coating disposed thereon.

12. A rack for supporting pieces of meat within oil in a deep fryer, comprising a structure and one or more meat supporting members supported by the structure, the one or more meat supporting members extending along a longitudinal axis and being spaced apart from neighbouring elements of the rack by a minimal distance in a radial direction relative to the longitudinal axis, the minimal distance selected such that, when mounted on a first one of the meat supporting members, each of the pieces of meat is free from contact with the neighbouring elements of the rack and/or free from contact with adjacent pieces of meat received on a second one of the meat supporting members.

13. The rack of claim 12, wherein the neighbouring elements belong to one of the structure and/or the meat supporting members.

14. The rack of claim 12, wherein the structure includes a base, the meat supporting members secured to the base.

15. The rack of claim 12, wherein the structure includes a base and at least one upstanding portion secured to the base and extending away therefrom, the meat supporting members removably securable to the at least one upstanding portion and extending away therefrom.

16. A rack for supporting pieces of meat within oil in a deep fryer, comprising; a base, at least one upstanding portion secured to the base and extending away from the base; and meat supporting members supported by the at least one upstanding portion, the meat supporting members extending from the at least one upstanding portion along longitudinal axes thereof, the meat supporting members separated from each other by a minimum distance taken along radial directions relative to the longitudinal axes, the minimum distance selected such that two pieces of meat received on two adjacent ones of the meat supporting members are substantially free of contact with each other.

17. The rack of claim 16, wherein the meat supporting members are removably securable to the at least one upstanding portion.

18. The rack of claim 16, wherein the meat supporting members are spear assemblies including each two spears configured to be inserted in the pieces of meat.

19. The rack of claim 16, wherein the at least one upstanding portion includes two upstanding portions secured to opposite sides of the base, each of opposed ends of the meat supporting members removably securable to a respective one of the two upstanding portions.

20. The rack of claim 19, wherein the two upstanding portions define slots for slidably receiving ends of the meat supporting members.
